(19) United States
(12) Patent Application Publication
(10) Pub. No.: US 2004/0211507 A1
(43) Pub. Date: Oct. 28, 2004

(54) Method and apparatus for repairing vinyl and leather

(75) Inventor: Lawrence Speer, Parks, AZ (US)

Correspondence Address: D. Peter Hochberg Co., L.P.A., The Baker Building, 6th Floor, 1940 East 6th Street, Cleveland, OH, 44114-2294, US

(73) Assignee: Leatherize, A Division of Longevity Corporation of America

(21) Appl. No.: 10/422,144

(22) Filed: Apr. 24, 2003

(51) Int. Cl. B32B 35/00

(52) U.S. Cl. 156/94

(57) ABSTRACT

A method and apparatus for repairing damaged vinyl or leather wherein polyurethane film covers the damaged area and is heated. Plastisol is inserted in the damaged area and a layer of grain paper is applied thereon. Heat is again applied at a temperature to sufficiently cure the plastisol but to not damage the material surrounding the damaged area.

### BACKGROUND OF THE INVENTION

1. Field of the Invention

This invention relates to the repair of vinyl and leather, and more particularly to the repair and apparatus for repairing damage to vinyl and leather using plastisol repair compound.

2. Description of the Prior Art

Vinyl and leather are widely used for furniture, seats for land, water and air vehicles, clothing and in a tremendous variety of other areas. Vinyl and leather are often subject to considerable wear and are often damaged in that they incur holes, slits, tears and rips. It is well known in the industry to repair vinyl and leather using plastisol. Plastisol is a polyvinyl heat curing component consisting of a mixture of a PVC resin and a plasticizer that can be molded, cast or made into a continuous film by the application of heat. In addition, plastisol may also include a coloring pigment. For example, Leatherize™ vinyl repair compound is a commonly employed plastisol. A plasticizer is well known, and is a chemical added specifically to rubbers and resins to impart flexibility, workability or stretchability. The conventional method and product for repairing vinyl and leather involves filling the damaged spot, which could be a hole or a slit, with a plastisol compound having the color of the product to be repaired. The plastisol is covered with a grained paper, and the grained paper is heated with a household iron or other vinyl repair heating tool. The object of this repair procedure is to provide a repaired product having the color and grain of the original vinyl or leather and be substantially as strong.

However, the present method of using plastisol is inappropriate for satisfactorily making the repair. The plastisol must be cured in order for it to assume the strength, wearability and to remain in place in the damaged area. When enough heat is applied to promptly cure the plastisol, it often happens that the heat is also applied to the undamaged area surrounding the damage to the vinyl or leather and the undamaged area loses its grain. The excessive heat applied to the plastisol further melts part of the vinyl or the coating on the leather and is, therefore, unsightly. In order to protect the surrounding vinyl or leather, less heat is often applied to the plastisol. However, although the repaired material looks better, the plastisol compound is not properly cured and is therefore weak and prone to damage. Therefore, an improved method and apparatus of applying and curing a plastisol compound to vinyl, leather and the like for repair of the vinyl, leather and the like is needed.

### SUMMARY OF THE INVENTION

An object of the invention is to provide a repair system for repairing damage to vinyl and leather using a process yielding stronger results than the prior system of using plastisol compound.

Another object of the invention is to provide a method for repairing damage to vinyl and leather using conventional materials to yield a faster, longer-lasting and stronger result.

Still another object of the invention is to provide a method for repairing holes, slits, rips and tears in vinyl or leather yielding results having the original grain and color of the vinyl or leather, in a faster method and yielding stronger results than the conventional method of using plastisol to make the repair.

A yet further object of the present invention is to provide an improved method for repairing damaged vinyl or leather that is fast, efficient and economical.

Still yet another object of the of the present invention is to provide a method for repairing damage to vinyl and leather using conventional materials and that requires the use of heat application at a lower temperature than other conventional methods.

Still yet a further object of the present invention is to provide a method for repairing damage to vinyl and leather using conventional materials in lesser amounts than is used with conventional methods.

Other objects of the invention may occur to those of ordinary skill in the art upon reading of the following specification and the appended claims.

The foregoing objects are achieved according to the preferred embodiment of the invention wherein a polyurethane film is applied across the hole, slit, rip or tear in the vinyl or leather and grain paper is applied thereon and heated. After heat application, the grain paper is removed. Subsequently, plastisol is applied to the damaged portion of the vinyl or leather to which heat is applied again. The heat should be a high enough temperature to properly cure the plastisol, but not be of sufficient magnitude to damage the surrounding vinyl or leather.

In another version of the preferred embodiment, a polyurethane film is applied to one side of the vinyl or leather with grain paper placed thereon, heated and removed as indicated above. Plastisol is applied to sit on the film, and a further polyurethane film is applied on the other side of the vinyl or leather to form a sandwich construction. A heating tool is then applied to the film and plastisol of sufficient magnitude to cure the plastisol, the heat being of insufficient temperature to damage the vinyl or plastisol.

Another variation on the preferred embodiment is to apply more than one layer of polyurethane to increase the strength of the repairing product. In some situations involving slits, rips or tears to vinyl or leather, the invention involves the mere application of a polyurethane film, and the heating of the film in the manner indicated above for a short period of time, such as about 10 seconds, to secure the engagement of the film to the vinyl or leather. A secure repair is accomplished without the necessity for using plastisol, and the repair site is often not visible.

### BRIEF DESCRIPTION OF THE DRAWINGS

FIG. 1 is a perspective view of a piece of vinyl or leather having a film applied over damage to the vinyl or leather;

FIG. 2 is a cross section of vinyl or leather having a film applied across the damaged area, and a heating tool being applied to the vinyl or leather;

FIG. 3 is a cross section of a piece of vinyl or leather having a damaged area, with plastisol in the damaged area, and polyurethane film applied to one side of the vinyl or leather across the damaged area, and a heating tool moving across the damaged area;

FIG. 4 is a cross section of a piece of vinyl or plastic having plastisol in the damaged area, and two layers of polyurethane film extending across the damaged area;

FIG. 5 is a cross section of a piece of vinyl or leather, with plastisol in the damaged area and polyurethane film on both sides of the damaged area;

FIG. 6 is a perspective view of a piece of vinyl or leather with polyurethane film extending over a slit, tear or rip in the vinyl or leather; and

FIG. 7 is a perspective view of the reverse side of the vinyl or leather shown in FIG. 6.

### DETAILED DESCRIPTION OF THE PREFERRED EMBODIMENTS

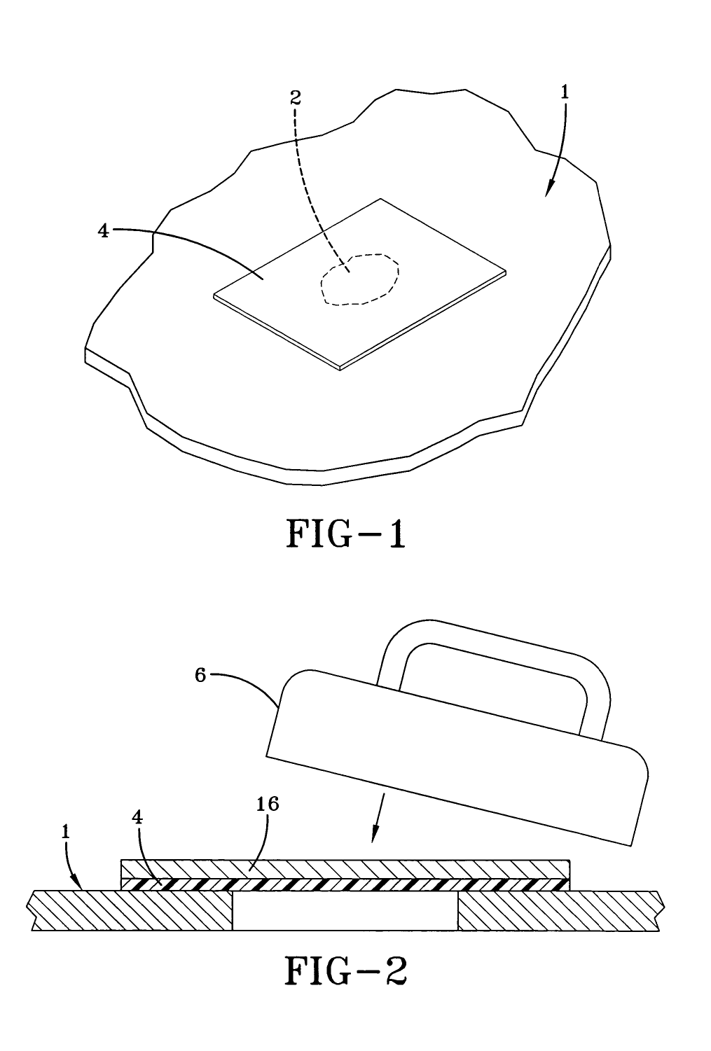

FIG. 1 shows a piece of vinyl or leather 1 having damage in the form of a hole 2 located therein. In order to repair the hole according to the present invention, a polyurethane film 4, such as Leatherize™ polyurethane film, is provided over the damaged area 2, preferably on the top of the vinyl or leather. The polyurethane film 4 is preferably between one and ten mils thick. The polyurethane film 4 is easily softened and can be attached to vinyl or leather upon the application of sufficient heat. Referring to FIG. 1, polyurethane film 4 is supplied over the damaged area. A first thin layer of a vinyl repair compound (i.e. plastisol) is preferably applied around the edges of the damaged spot to help ensure that the polyurethane layer 4 will affix to the spot sufficiently. Of course the aforementioned thin layer of plastisol can be either clear or colored. Then, as shown in FIG. 2, a layer of grain paper 16 is placed over the polyurethane layer 4 and an iron or other heating tool 6 is passed over film 4 and layer 16 for about 10 seconds to attach film 4 over damaged area 2, thereby forming a pocket-like structure in the damaged area 2. Grain paper layer 16 is removed after the application of heat. The polyurethane layer 4, after receiving sufficient heat treatment, bonds the sides of the damaged area 2 together and fills at least part of the damaged area 2 so that less of the repair compound needs to be used.

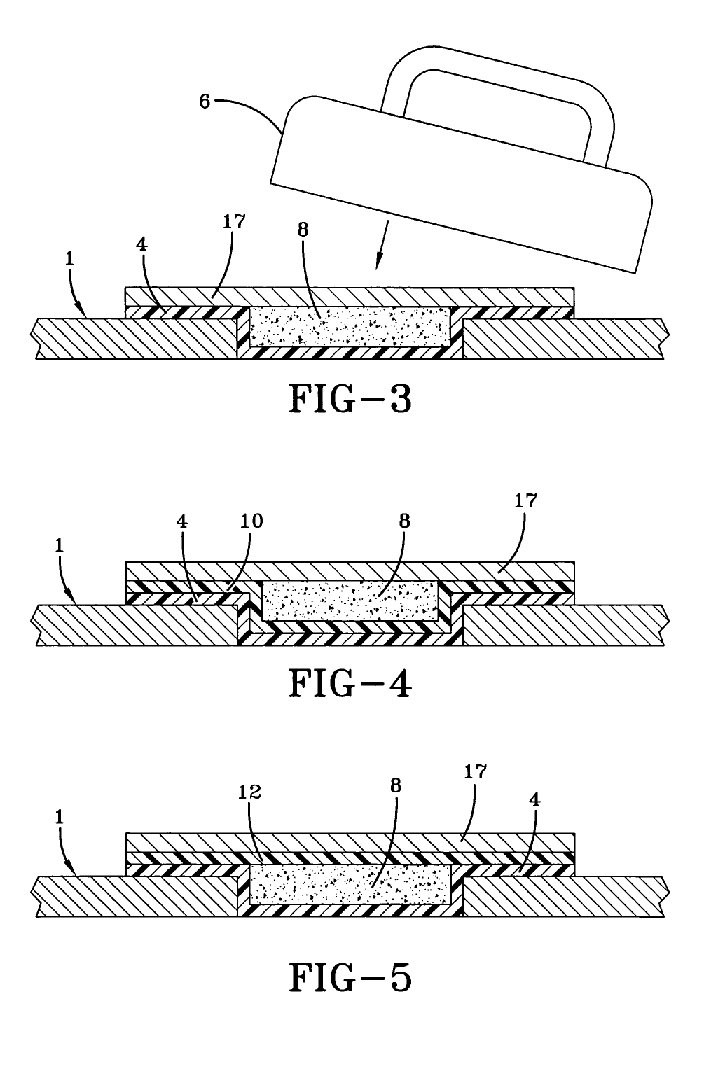

After the polyurethane layer 4 is heated and secured, a thin layer of a plastisol repair compound 8, such as Leatherize™ vinyl repair compound, is spread over the polyurethane layer 4, as shown in FIG. 3. The plastisol layer 8 may include a colored compound being the same color as the leather or vinyl surrounding the damaged area 2. A second thin layer of grain paper 17 is then placed on the plastisol layer 8, thereby sandwiching the plastisol layer 8 therebetween. Heating tool 6 is subsequently passed over the top of the grain paper 17, thereby heating all three of polyurethane layer 4, plastisol layer 8 and grain paper 17. The heating effectively cures the plastisol layer 8 without causing damage to the surrounding leather or vinyl. Grain paper is commonly used in the art and imparts its grainy texture, upon being heated, into both the plastisol layer 8 and the polyurethane layer 4. Grain paper 17 is easily removed by simply peeling it off the damaged area 2 after the final heat application. It is preferred that heating tool 6 is used to apply direct heat to the damaged area 2 at a temperature of about 300-350° F. and for about 10-15 seconds, preferably 10 seconds. Since the heat required to cure plastisol 8 or to secure polyurethane film 4 to vinyl or leather 1 is less than the heat necessary to damage the vinyl or leather portion surrounding damaged area 2, one can apply sufficient heat to cure the plastisol and to secure the film without damaging the vinyl or leather. In addition, it should be appreciated that the initial heating application of the polyurethane film may be omitted and just one heating application in order to cure the plastisol may be employed.

Referring now to FIG. 4, in order to increase the strength of the polyurethane film, one can add a second layer of polyurethane film 10 on top of polyurethane film 4 and attach both layers to vinyl or leather 1 in the manner described above. Plastisol layer 8 is applied after grain paper 16 (not shown in FIG. 4) is removed and a layer of grain paper 17 is placed thereon. A heating tool 6 is used to cure the plastisol layer 8 as described above. In order to provide an additional support to the damaged area, it is also possible to add a second layer of polyurethane film 12 on the plastisol layer 8 before the layer of grain paper 17 is applied, to sandwich the plastisol 8 between the layers 4 and 12, as shown in FIG. 5. In order to make the foregoing arrangement, one would apply polyurethane layer 4 to one side of the vinyl or leather 1 over the damaged area 2, apply heat, in the manner described above, to attach or secure the layer 4 to the vinyl or leather 1, and apply plastisol 8 in the damaged area to rest on the first layer of polyurethane film 4. Another layer of polyurethane film 12 is then applied above the layer of plastisol 8, with a layer of grain paper 17 applied thereon. The various layers are heated by heating tool 6, as described above, and the layer of grain paper 17 is subsequently pulled away. The repair job as shown in FIG. 5 is as strong or stronger than the original undamaged material.

Sometimes the damaged area can be a slit, tear or rip in the vinyl or leather 1. Referring to FIG. 6, a slit, tear or rip 14 is shown. Side 20 of vinyl or leather 1 is shown having the slit, tear or rip 14. Over this, a layer of polyurethane film 18 is applied as shown and secured in the same manner as described above. Of course, the application of a plastisol layer and a grain paper layer, or even an additional polyurethane layer, in the manner as explained above, may also be included.

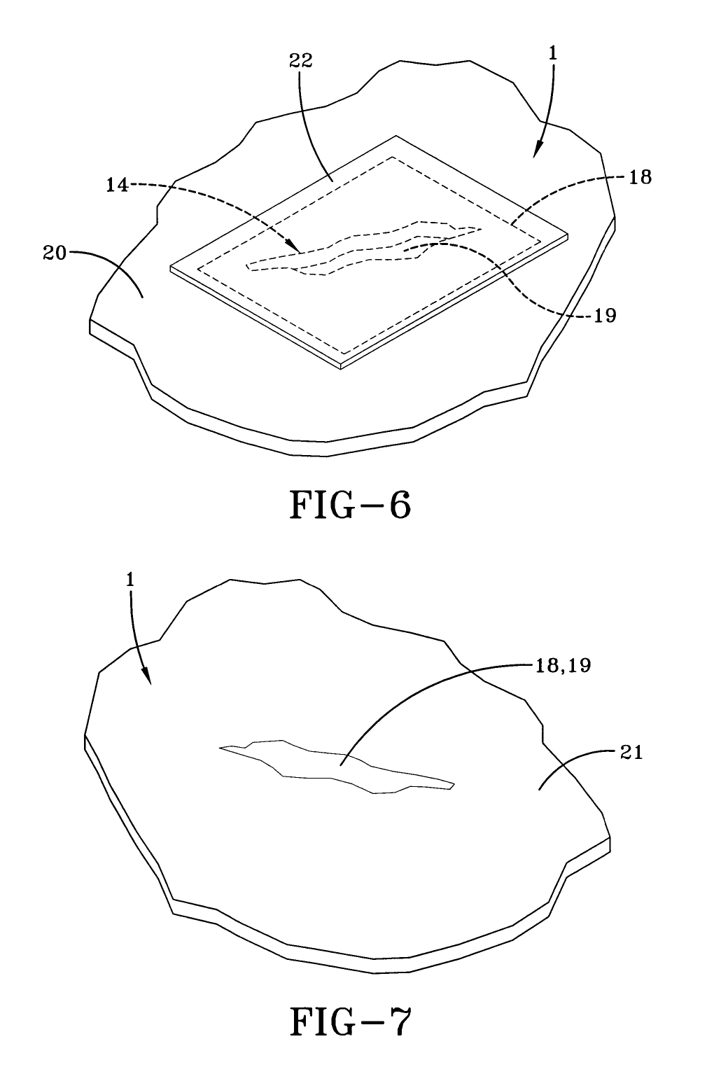

Alternatively, a one-step process could be used for a relatively smaller damaged area whereby layer 18 is applied, plastisol 19 is applied thereon, and a layer of grain paper 22 is applied, all of which are heated. Layer 22 is then removed. If one were to view the repaired vinyl or leather as shown in FIG. 7, one would find that there is no visible sign of the slit, tear or rip on the finished side 20 of vinyl or leather 12.

It can thus be seen that the present invention provides a fast yet very inexpensive way to repair damaged vinyl or leather using low-cost, easily available materials using a simply-to-use process. Accordingly, such damaged areas as school bus seats, car seats, or other leather/vinyl products, as well as a variety of other items can easily be repaired in a strong yet not readily noticeable repair job. Kits could be provided having the necessary raw materials, i.e., plastisol and polyurethane film, so that nearly any person could make the repairs as required.

The invention has been described in detail with particular emphasis on the preferred embodiments thereof, and variations and modifications may occur to those skilled in the art to which the invention pertains from the foregoing application, drawings and the appended claims.

What is claimed is:

1. A method for repairing a damaged area in vinyl or leather, said method comprising the following steps:
applying a layer of polyurethane film over the damaged area;
applying plastisol compound in the damaged area to rest on the polyurethane film;
applying a layer of grain paper over said plastisol; and
applying sufficient heat to cure the plastisol compound and not damage the vinyl or leather surrounding the damaged area.

2. A method for repairing a damaged area in vinyl or leather according to claim 1, and further including the steps of:
applying an initial layer of grain paper over said polyurethane layer before said plastisol compound is applied;
applying heat over said grain paper to secure said polyurethane to the damaged area; and
removing said initial layer of grain paper.

3. A method according to claim 1 and further comprising adding a second layer of polyurethane film, said second layer of polyurethane film being applied on said layer of plastisol compound and before application of said layer of grain paper, to sandwich the plastisol between the two layers of polyurethane film, and applying sufficient heat to cure the plastisol but not damage the vinyl or leather surrounding the damaged area.

4. A method according to claim 1 and further comprising the step of adding at least one other layer of polyurethane film on top of said first layer of polyurethane film before application of said initial layer of grain paper.

5. A method according to claim 1 wherein said polyurethane layer has a thickness of between one and 10 mils.

6. A method according to claim 1 wherein said heat is applied at a temperature of between 300° and 350° F.

7. A method according to claim 6 wherein said heat is applied for about between 10 and 15 seconds.

8. A method according to claim 7 wherein said heat is applied for 10 seconds.

9. A method according to claim 1 wherein said plastisol contains a colored compound.

10. Apparatus for repairing a damaged area on vinyl or leather, said apparatus comprising:
polyurethane film for being applied over the damaged area;
plastisol compound for being applied over the damaged area and resting on the polyurethane film; and
a layer of grain paper placed on top of said plastisol compound; said polyurethane film, grain paper and plastisol compound being heatable to cure said plastisol compound but not requiring sufficient heat to damage the vinyl or leather surrounding the damaged area.

11. Apparatus according to claim 10 and further comprising another layer of polyurethane film for being applied to the top of said plastisol compound in the damaged area for sandwiching said plastisol compound between the layers of polyurethane film.

12. Apparatus according to claim 10 and further comprising a second layer of polyurethane film for being applied over said layer of polyurethane film.

13. A method for repairing a slit, tear or rip in vinyl or leather comprising applying a layer of polyurethane film to the slit, tear or rip, and applying sufficient heat to the film to adhere the film to the vinyl or leather without damaging the undamaged part of the vinyl or leather surrounding the slit, tear or rip.

14. A method according to claim 13 and further including the step of adding a layer of grain paper over said polyurethane film before the application of said heat.

15. A method for repairing a damaged area in vinyl or leather, said method comprising the following steps:
applying a layer of polyurethane film over the damaged area;
applying an initial layer of grain paper over said polyurethane layer;
applying heat over said grain paper to secure said polyurethane to the damaged area;
removing said initial layer of grain paper;
applying plastisol compound in the damaged area to rest on the polyurethane film;
applying a second layer of grain paper over said plastisol;
applying sufficient heat to cure the plastisol compound and not damage the vinyl or leather surrounding the damaged area; and
removing said second layer of grain paper.
